(19) United States
(12) Patent Application Publication
(10) Pub. No.: US 2023/0390904 A1
(43) Pub. Date: Dec. 7, 2023

(54) TIGHTENING TOOL EQUIPPED WITH A TIGHTENING QUALITY CONTROL DEVICE

(71) Applicant: ATLAS COPCO INDUSTRIAL TECHNIQUE AB, Stockholm (SE)

(72) Inventor: UWE BRECHENMACHER, Baiersbronn (DE)

(73) Assignee: ATLAS COPCO INDUSTRIAL TECHNIQUE AB, Stockholm (SE)

(21) Appl. No.: 18/033,529

(22) PCT Filed: Oct. 26, 2021
(86) PCT No.: PCT/IB2021/059875

§ 371 Date: Apr. 24, 2023

(30) Foreign Application Priority Data
Oct. 28, 2020 (IT) 102020000025588

(51) Int. Cl. B25B 23/142

(52) U.S. Cl. CPC B25B 23/1425

(57) ABSTRACT

Tightening tool comprising a body (11), containing control circuits and an electronic processing unit having at one end a handle (12) for gripping by an operator performing the tightening, and at the other end an arm (13). Such arm at its free end comprises a seat (16) into which a plurality of inserts can alternatively be inserted, suitable for engaging the tool with a corresponding type and/or size of a mechanical member on which the tool is intended to act to perform a tightening operation. Sensor means are provided on said arm suitable for detecting tightening conditions exerted on said mechanical member. Such sensor means comprise at least one inertial measurement unit (IMU) connected to such electronic processing unit, capable of detecting tool rotations about the three cartesian axes (x, y and z) and direct accelerations along such axes.

The present invention refers to an electronic tool for the controlled tightening of mechanical members; such tool can be for example a torque wrench in which it is possible to check the tightening quality through a relevant control device.

Tightening tools are known in the art which comprise a body, containing the various control and, optionally, actuation members, to which one of several removable inserts is coupled, each of which is intended to engage a corresponding type of mechanical member (e.g. the head of a screw, with male or female coupling) on which the tool is intended to operate.

Electronic tools of this type comprise sensors, including a torque sensor, for detecting the torque exerted on the mechanical member and other relevant quantities, so that the mechanical member can be tightened, which, by means of appropriate sensors and processing means, shows the operator whether the desired tightening torque has been reached.

Patent EP2326464 describes a tool of this type in the form of a torque wrench, which comprises a body, containing the control circuits and processing unit of the wrench, on one side a handle (advantageously containing rechargeable batteries for powering the wrench) and on the other side an arm. Advantageously, a display for viewing information and operating data is provided on the body and a keyboard allows data and commands to be entered. A tool head which must be coupled with the type of mechanical member (for example, the head of a screw, with male or female coupling) on which the wrench is intended to operate is inserted interchangeably in a special seat at the end of the arm.

The sensors which measure the torque to be exerted on the member to be tightened are placed on the arm and comprise at least one strain gauge, which is a sensor whose electrical resistance varies with the deformation it undergoes; so it converts the force, pressure, voltage, weight, etc., into a variation in electrical resistance that can be measured.

The value of torque exerted is normally available on the wrench display or is indicated near it by means of special light and/or acoustic signalling. The signals from the sensors on the arm are transmitted to the central processing unit.

The tightening torque value is not the only parameter that determines whether tightening has been performed satisfactorily. There are in fact other parameters and conditions that could be monitored to check whether the tightening tool has been used correctly.

For example, in order to check the correct operation of a torque wrench, it would be necessary to check whether the wrench has ever been subjected to accidental falls or significant shocks (free fall detection), which could have damaged the mechanical structure, changed the measurements of the sensors, or anything else. In addition, the torque sensor is not sufficient on its own to determine whether the bolt has been fully tightened (bolt finished status), e.g. if a screw is tightened vertically, the tightening direction may not have been optimal (bolt angle mismatch).

In some cases, when the wrench is used to tighten a series of bolts, it is almost impossible to control the inclination of all of them. During use, operators may handle the wrench incorrectly with respect to the inclination of the bolt to be tightened. It is therefore possible that the operator has forgotten to tighten a part, or has only partially tightened it without reaching full tightening.

The applicant has solved these problems by equipping the tightening tool with an inertial measurement unit capable of detecting rotations and accelerations along the three Cartesian axes x, y and z. The signals from this unit are sent together with the data from the torque sensors to a microprocessor electronic board, which is able to carry out processing and identify the conditions of the wrench and the conditions of the tightening operations.

One aspect of the present invention relates to a tightening tool having the features of claim 1.

Further objects and advantages of the present invention will become clear from the following description and from the attached drawings, provided purely by way of non-limiting example, in which:

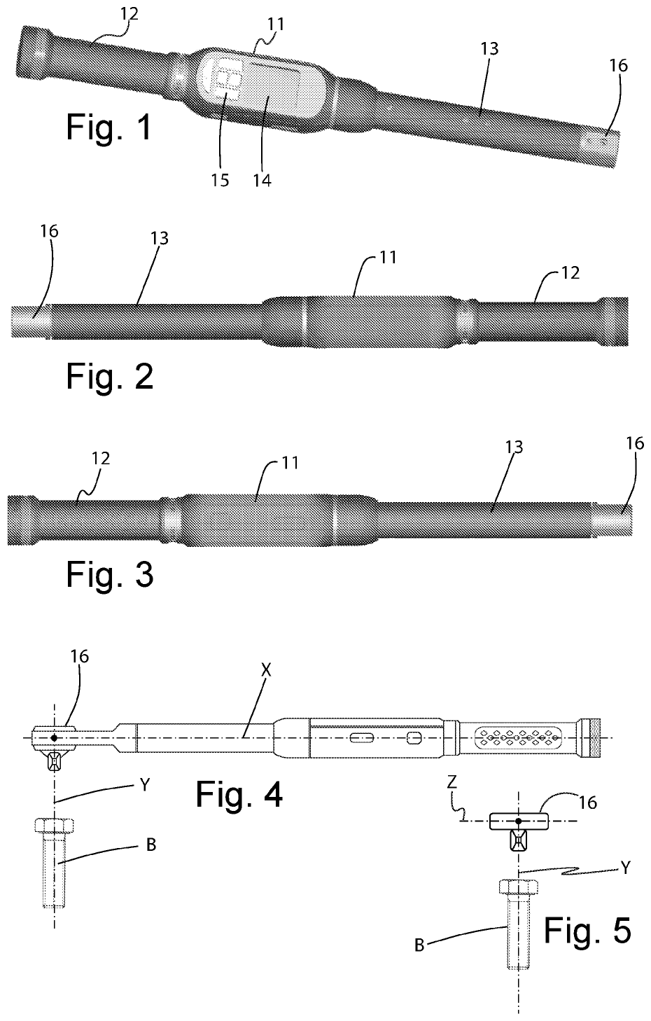

FIG. 1 is a perspective view of the tightening tool according to the present invention;

FIGS. 2 and 3 are front and rear views of the tool of FIG. 1;

FIG. 4 shows a side view of a torque wrench aligned with the bolt to be tightened, showing the axes of the possible rotations of the wrench;

FIG. 5 shows a front view of a torque wrench aligned with the bolt to be tightened, showing the axes of the possible rotations of the wrench.

With reference to the aforementioned figures, the tightening tool according to the present invention is a torque wrench and comprises a body 11 containing electronic control circuits having on one side of said body a handle 12 (preferably containing rechargeable batteries for powering the tool) and on the other side an arm 13. Advantageously, a display 14 for viewing information and operating data is provided on the body 11 and a keyboard 15 allows data and commands to be entered.

Naturally, it is understood that if the processing or storage of data requires a unit which cannot be easily or completely contained in the body 11, the body 11 can be connected, by means of a cable or a wireless connection, to external processing units. A wired connection can also be envisaged to provide external power supply. A plurality of inserts can be alternatively pluggable in a suitable seat 16 at the end of the arm 13. For example, each insert will be suitable for engaging the wrench with a corresponding type and/or dimension of mechanical member or element (screw, nut, etc.) on which the tool is destined to operate.

Although for simplicity's sake inserts all having a similar dimension are shown, elongated inserts or inserts with arms of a particular shape can also be provided, as known in the art.

Each insert may comprise internally a transponder in a suitable position (typically in the plugging shank to the seat 16) to be coupled to a suitable antenna close to the seat 16 when it is mounted on the tool.

The manners for coupling between transponder and antenna for the activation of the transponder (usually known as “tag”) and the communication are widely known and will therefore not be described in detail here.

The tool comprises sensors of the torque exerted on the mechanical member, made with groups of strain gauges preferably arranged in the arm.

According to an aspect of the present invention, the tightening tool comprises an inertial measurement unit (IMU) capable of detecting rotations about the three Cartesian axes x, y and z and direct accelerations along these axes.

Such unit is connected to the central processing unit of the tool, and can take the following measurements during tightening.

For example, during the tightening of a B-bolt, by analysing the acceleration on the Y-axis (bolt tightening axis), it is possible to understand whether the tightening operation has been interrupted or whether the bolt has been tightened completely. In addition, by measuring parameters such as torque and tightening angle (via the IMU), it is possible to determine whether tightening has been carried out in several stages or in a single action to completion.

By measuring the acceleration along the tightening axis it is possible to detect a possible misalignment between the theoretical and actual tightening axes, thus understanding whether the bolt has not been tightened along the correct axis, possibly damaging the thread of the hole.

When a conventional wrench is used to tighten a series of bolts, it is almost impossible to control the inclination of all the bolts during tightening. In fact, during use, operators may handle the wrench incorrectly with respect to the inclination of the bolt to be tightened. When the wrench is used to tighten the same type of bolt each time, the inclination is known but the operator cannot precisely control it without using another tool.

Using the inertial gauge, on the other hand, by measuring the acceleration and therefore the rotation of the wrench with respect to the torque application point and having stored a predefined tightening sequence in the processing unit, it is possible to understand whether the tightening operations on all bolts have been carried out correctly.

Another problem that can be avoided is if the operator starts to tighten a bolt, gets distracted and then starts to tighten the wrong one again, which is at a different inclination. Through the measurement of the IMU and by detecting the predefined tightening sequence stored in the processing unit, the system can issue a fault signal.

Joint inclinations can also be recorded in the tightening sequence. This makes the measurement made in the previous point even more useful, in which not only the direction between one bolt and the next is measured but also their inclination.

Acceleration measurement can also provide indications on whether the tool has been subjected to shocks or falls involving sudden deceleration. These measurements can be stored and evaluated to determine whether the wrench can still be used afterwards, or whether it requires maintenance or repair.

In addition, acceleration readings can allow the tool's electronic processing unit to rotate the digital display, compatible with the axis of gravity, to make it easier for the operator to read the data on the display during use.

1. Tightening tool comprising
a body (11), containing control circuits and an electronic processing unit having at one end a handle (12) for gripping an operator who performs the tightening, and at the other end an arm (13),
said arm at its free end comprising a seat (16) in which a plurality of inserts suitable for engaging the tool with a corresponding type and/or size of a mechanical member on which the tool is intended to act to act perform a tightening operation,
on this arm there are sensor means suitable for detecting the tightening conditions exerted on this mechanical member,
characterized in that said sensor means including at least one inertial measurement unit (IMU) connected to such an electronic processing unit, capable of detecting tool rotations around the three cartesian axes (x, y and z) and direct accelerations along said axes.

2. Tool according to claim 1, wherein said unit (IMU) detects the acceleration that is impressed along the bolt tightening axis (Y) to check if there have been any interruptions in the tightening operation.

3. Tool according to claim 1, wherein said unit (IMU) measures the acceleration along the tightening axis to detect a possible misalignment between the theoretical tightening axis and the real one, thus understanding whether the tightening of the bolt does not was performed along the correct axis.

4. Tool according to claim 1, wherein said unit (IMU) measures the acceleration and therefore the rotation of the wrench with respect to the point of application of the tightening torque and having stored a pre-defined tightening sequence in the processing unit, by comparison with these predefined sequences, it is possible to verify the correct tightening sequence.

5. Tool according to claim 1, wherein said unit (IMU) measures any sudden decelerations that can be stored and evaluated, to define if after the wrench it can still be used, or if it requires maintenance or repairs.
